(19) United States
(12) Patent Application Publication
(10) Pub. No.: US 2009/0043883 A1
(43) Pub. Date: Feb. 12, 2009

(54) Method for Monitoring a Technical Appliance

(76) Inventors: Alexander Aydt, Stuttgart (DE); Bernhard Feurer, Stuttgart (DE); Arno Pernozzoli, Grafenberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/990,469

(22) PCT Filed: Aug. 2, 2006
(86) PCT No.: PCT/EP2006/064978

§ 371 Date: Feb. 14, 2008

(30) Foreign Application Priority Data
Sep. 1, 2005 (DE) 10-2005-041-632.2

(51) Int. Cl. G06F 15/16

(52) U.S. Cl. 709/224

(57) ABSTRACT

There is described a method and a device which is suitable for carrying out said method. Said method monitors a technical device, wherein a communication connection is established or can be established between the technical device and a device for supporting the monitoring. Data communication with the device for supporting monitoring is carried out by means of the communication connection. The technical device is monitored in a flexible manner possible. The monitoring of the technical device can be configured in such a way that modifications of a monitoring configuration can be transmitted from the device to the monitoring support on the technical device. The internet is used, in particular, for transmission, and the device for supporting monitoring is a webserver.

### CROSS REFERENCE TO RELATED APPLICATIONS

This application is the US National Stage of International Application No. PCT/EP2006/064978, filed Aug. 2, 2006 and claims the benefit thereof. The International Application claims the benefits of German application No. 10 2005 041 632.2 DE filed Sep. 1, 2005, both of the applications are incorporated by reference herein in their entirety.

### FIELD OF INVENTION

The invention relates to a method for monitoring a technical appliance. The technical appliance is for example an automation appliance, such as e.g. a machine tool, a production machine or an automatic handling machine. Other examples of technical appliances are automation components such as a static converter, a PLC (Programmable Logic Controller), an NC controller, a CNC controller or the like. Automation components of this kind are used in automation equipment such as e.g. printing presses or plastic injection molding machines (these are examples of production machines) or also in lathes or milling machines (these are examples of machine tools), or also for robots (this is an example of an automatic handling machine). These are industrial machines.

### BACKGROUND OF INVENTION

Internet technologies offer a way to enable remote monitoring and remote diagnosis of automation appliances. On a user side is a system-specific operator control station enabling a user to carry out an interrogation from a remote location. Remote monitoring enables e.g. one or more experts to access an industrial machine.

It is disadvantageous in this case that the data needs to be analyzed by means of human labor such as e.g. by a group of experts or by at least one expert. The analysis also includes, for example, pronouncements on troubleshooting measures. Messages, in particular error messages, from at least one industrial machine are diagnosed by experts e.g. centrally by way of remote monitoring or locally. The experts receive notification of the messages via a human-machine interface (HMI). The experts acquire their know-how through knowledge of the industrial machines generating the messages. This knowledge was built up for example as a result of the fact that the experts know at least one error message from an industrial machine already from another industrial machine of the same type, where they have rectified the error or fault by means of troubleshooting measures. The troubleshooting measures are thus known to the experts and are also applied to remove the error or fault on another industrial machine of the same type. Knowledge of error messages and the associated troubleshooting measures is also acquired for example as a result of studying only one industrial machine over a period of time.

A troubleshooting system is produced as a result of the message diagnosis carried out by personnel, said diagnosis being set up e.g. as a centralized function, and knowledge of the industrial machine or machines which generates or generate messages, since the experts contribute to the troubleshooting process e.g. by way of remote accesses or locally, or also by way of local personnel.

However, a method for centralized and/or local message diagnosis by means of experts throws up many problems, such as e.g. the experts' speed of response, working hours, round-the-clock availability, differences in the expert knowledge of different experts, knowledge of foreign languages, and much more.

A system which has a host and a client, wherein machine status data is captured by the client in realtime and transferred to the host, is known from DE 101 52 765 A1. The host can be connected to the client e.g. via the internet.

In a monitoring method there may also be a problem to the extent that causes of an exception situation, such as e.g. an error, a malfunction or the like, affecting technical systems, e.g. a machine tool, are to be determined with system support on the basis of diagnostic expertise. In this case the diagnostic expertise relating to a technical system, a technical appliance, a machine, installation or the like, referred to in the following for the sake of conciseness as a technical system or technical appliance, must be easily extensible in the sense that additional knowledge can be incorporated without adversely impacting the knowledge that already exists.

If one or more faults occur on a technical appliance, such as e.g. a controller, said fault or faults must be diagnosed and removed for example by the operator of the technical appliance or else by the manufacturer of the technical appliance. The fault is detected as a result of the monitoring of the technical appliance. To identify an error which represents a fault, the error is detected e.g. from monitored signal shapes of the controller, with additional data from the technical appliance, for example as a result of its being stored, advantageously being made available for a further diagnosis. The possibility of recording all relevant signals for potentially occurring errors with a e.g. subsequent identification of the relevant signal states is critical in particular in the case of complex technical appliances such as e.g. controllers in automation technology, since the latter are generally severely limited in terms of resources and the signal files to be recorded would become very extensive. The limitation in terms of resources relates in particular to the available memory and/or the computing power of the technical appliance. Consequently, monitoring by observing and recording all signals of a technical appliance for subsequent use for error and/or fault analysis generally exceeds the capacity of the technical appliance in terms of memory and computing power. For this reason, according to the prior art, a selection of monitored signals is made during the programming of a technical appliance. As said selection is limited, it becomes more difficult in many cases to detect e.g. an error or a fault quickly and accurately. If, e.g. in response to the detection of certain signal states (e.g. error states) or their combinations, data is to be obtained from a controller e.g. for diagnostic purposes, then said data must also be known at the time of implementing the automation project. The data is acquired for example when a specific predefined error occurs, such that the data is then stored for example in a logbook file in a specially protected area. This stored data can then be made available if necessary for an error diagnosis. The error diagnosis can be carried out by a person or also by an expert system. Generally it is not possible to record all the data required for diagnoses, with the result that the error diagnosis is made more difficult.

Thus, if signals or data resulting from a monitoring of the technical appliance are to be captured using the same controller that also controls the process and without adding new diagnostic hardware and without intervening e.g. in a production process—in particular forcing its shutdown—, the data or signals required for monitoring must be known at the time of implementing e.g. an automation project and must be resident in the software of the controller of the production process. This applies in particular:
to signals from sources in which only the analysis in (soft) realtime provides information about the error, or
if specific data is to be obtained from the controller at precisely the time of the error (“status dump at error time”).

The latter is only possible directly at the time of detection of a fault and in principle cannot be accomplished by means of a subsequent analysis of signal data.

DE 197 49 002 A1 discloses a press monitoring system. A monitoring unit having a processor is provided locally on the press. The local unit is connected via a data link to a remote unit which likewise has a processor. The remote unit can change the configuration of both the hardware and the software of the local unit via the communication network.

WO 02/069064 A1 discloses a switch cabinet having a monitoring device for switch cabinet functions. The monitoring device is engaged in a data transmission connection with a server switching device which is likewise arranged in the switch cabinet and has a display control device. The monitoring device is embodied for recording configuration data input via the display control device.

### SUMMARY OF INVENTION

An object underlying the invention is to provide a method for monitoring a technical appliance and a corresponding system for monitoring the technical appliance which allow improved monitoring of the technical appliance.

The object is achieved by means of a method having the features recited in an independent claim.

In an inventive method for monitoring a technical appliance, a communication link is used between the technical appliance and an appliance for providing monitoring support. The technical appliance is for example an automation appliance or possibly an automation component. A telephone line, an internet connection, an intranet connection, an Ethernet connection or the like, for example, is also used at least partially as the communication link. The communication link enables a data exchange to be established between the technical appliance and the appliance providing monitoring support. For this purpose the monitoring appliance and/or the technical appliance includes in particular a data communication appliance. Examples of data communication appliances are a bus connection, a modem, a web server, etc. According to the invention the method is embodied in such a way that the monitoring of the technical appliance is configurable, with changes to a monitoring configuration being transferred or transferable from the monitoring support appliance to the technical appliance. The transfer takes place by means of the communication link. The monitoring support appliance is for example a personal computer, a server, a workstation or the like.

The monitored technical appliance is for example an automation appliance such as e.g. a machine tool or a production machine. As a result of using the communication link it is possible for example to export compute-intensive and/or memory-intensive monitoring tasks to the monitoring support appliance.

According to the invention it is provided that the monitoring support appliance is connected in a serial and/or parallel sequence to two or more technical appliances for the purpose of performing a data communication, with the configuration setting, i.e. the monitoring configuration, of a first technical appliance being switched over as a function of a status of a second technical appliance. Thus, if, for example, a folding apparatus of a printing press reports an error, the monitoring configuration of the last printing unit can be changed specifically in order to establish whether the error in the folding apparatus possibly originates from the printing unit.

The method according to the invention can be embodied in such a way that in particular in connection with the detecting of errors during the operating time of the technical appliance and the accompanying acquisition of (diagnostic) data that is present in particular on a controller, both monitored signals and/or signal states as well as data to be generated thereby can be configured during the operating time of the technical appliance. In this case the configurability relates in particular also to the generation of further diagnostic actions. According to the inventive method, for example, errors on the basis of which e.g. error messages were generated are easier to pinpoint. According to the prior art, in order to pinpoint the error it was necessary to carry out special changes e.g. to automation software of a technical appliance in order, for example, to build an intercept circuit for error detection, in which case the normal operation of the technical appliance had to be interrupted for this purpose. Modified software was loaded e.g. into a controller which represents the technical appliance during the operational interruption either locally or by remote access. After the error was found, the controller could be reset to the initial status during an operational interruption in respect of the software. This approach has the disadvantage that the ongoing operation of the technical appliance has to be interrupted in order to change the software provided for monitoring the technical appliance. For this purpose the local presence of an operator is also often necessary on site.

In an advantageous embodiment of the method according to the invention, a change to the monitoring configuration is therefore carried out during the operation of the technical appliance.

Since the monitoring of said technical appliance or also another technical appliance can be configured during the operation of the technical appliance, different fault situation patterns can be interrogated in a simple manner. Fault situation patterns can be detected e.g. as a result of specific signal states being reached by signals from different signal sources such as e.g. PLCs, NCs, process data servers, etc. and their logical dependencies which characterize for example the:

reaching

exiting

exceeding

undershooting

of a comparative value, the simultaneous occurrence of these conditions and/or the occurrence of these conditions in a defined sequence relative to one another. If these faults are to be made recognizable, a specific error pattern is typically described for that purpose at the time of implementation of an automation project e.g. using a PLC or NC language (“signal X=value 1 and signal y>value 2 inside z seconds→error message 1”) and output as an error message. The errors identified thereby can now be remedied during the operation of the system without halting the production process. This means that error states which were not known until after the implementation of an automation project, i.e. corresponding software, can still be detected as well by the controller by means of an online configuration change after the time of commissioning the system.

Monitoring configurations, for example, can be stored on a web server as monitoring settings and can be set up or adapted there by an operator at the time of operation of a controller. The monitoring configuration can be downloaded automatically, e.g. in the form of scripts in a script language, from a web server by a software component on the controlling and/or regulating appliance via a network connection and interpreted in the software component.

Advantageously it is also possible for the purpose of error detection in the controller of the technical appliance to access states which exist outside the controller or the monitored technical appliance. Further states of the technical appliance or of a technical process can make errors that have occurred more transparent and facilitate the diagnosis. This relates e.g. to data from a manufacturing execution system (MES), a maintenance planning system, a merchandise management system, etc. Accordingly, if further signal sources should prove necessary, which signal sources were not available for use as a signal source by the described technical appliance at the time of implementation of the technical appliance, the latter being in particular an automation system, then these can also advantageously be used as signal sources without halting the technical appliance and without installing software e.g. on the controller.

A machine alarm relating, for example, to contour monitoring of an axle can be used for error diagnosis, the message relating to a maintenance activity. Thus, for example, it can be reported that a recirculating ball shoe of the axle requires retightening, because said retightening is already more than two months overdue.

If a particular non-specific error is detected in a technical appliance such as e.g. a controller, it may be necessary in order to pinpoint the cause of the error more precisely to monitor other error patterns based on the detected error pattern or to acquire other diagnostic data. Given unlimited resources and error patterns known in advance, it would be possible to log all relevant signals or to record all the diagnostic data at any time (e.g. logging of all PLC signal shapes of interest at any time). However, this is not possible due to the generally limited resources (memory space, computing power, transmission bandwidth, . . . ) in the technical appliance itself.

According to the invention it is now possible that when a possibly very complex state of a technical appliance occurs, the state relating in particular to the status of a machine, monitoring of the appliance can be adapted to the special state. The state relates for example to a general error message from which the cause of the error is not immediately apparent. Access to different data sources of the technical appliance is possible for example by means of a software component. Data sources are e.g. sensors, actuators, controlling and/or regulating equipment and the like.

In an embodiment of the invention, a parameterizable PLC chip is used for monitoring PLC signals in realtime or in precise cycles. A PLC chip is integrated in the PLC (Programmable Logic Controller) in order to enable a cycle-precise response to signals. Said PLC chip carries out the check on signal states in accordance with the specifications from the configuration setting which are stored e.g. on the web server. This process can be based on scripts. The chip therefore implements within the PLC a signal state monitoring logic which can be configured as desired at the time of operation. Executing the PLC logic in a freely configurable PLC chip ensures a clock-precise detection of signal states without the precise logical combinations needing to be known at the time of implementation of the automation project.

Following is a list of examples of changes to the monitoring configuration for a technical appliance, with the change to the configuration being initiated at least jointly by means of the monitoring support appliance:
activating/deactivating further monitoring configurations,
transferring further data describing the technical appliance at this instant in time to a web server for diagnostic purposes (e.g. data and files from a PLC, an NC, a user interface, an HMI (Human-Machine Interface) and/or from an operating system or runtime system),
on the web server, initiating the sending of messages via different media (e.g.: SMS, email, etc.); according to the invention, the inventive monitoring method is consequently suitable generally for extension in that a message is generated by the technical appliance and/or the monitoring support appliance, whereby a function stored in the technical appliance and/or in the monitoring support appliance is triggered by the message,
influencing the processing logic of an appliance for controlling and/or regulating the technical appliance via a communication link to said controlling and/or regulating appliance,
informing a user at the technical appliance, in particular at an HMI of a machine, about events that have occurred and error states via messages on the HMI, and
initiating the generation of maintenance jobs.

As can be seen from the above list, the change to the monitoring configuration also relates in particular to actions that need to be performed e.g. as a consequence of a detected error (e.g. email to an operator, ordering of a replacement part by the technical appliance itself, . . . ). By attaching/detaching monitoring configurations when events or error states are detected it is possible by means of the described method to construct error trees. Particularly in the case of recurrently (and sporadically) occurring faults it is thus possible to pinpoint error states without consuming more controller resources.

A cascaded activation of error monitoring configurations or a situation-dependent diagnosis or situation-dependent data acquisition can also be performed. This succeeds in particular by activation/deactivation of a further monitoring configuration and/or by the deactivation of the appliance's integral detecting monitoring functionality. This enables a resource restriction to be avoided because in this way it is possible, based on a detected error, to pinpoint said error further (“drilldown” with the aid of an error tree) without consuming further resources on the technical appliance and in particular on a regulating and/or controlling appliance. In this case, after an event has been detected, a monitoring configuration can activate a different, even more suitable monitoring configuration and deactivate itself. This is useful primarily for isolating recurrently, yet sporadically occurring errors.

In addition to detecting errors and critical states, the monitoring can also be used for detecting further events. Signals for detecting an event can be logically combined not only with signals that are only present on the appliance for controlling and/or regulating the technical appliance, but also with such signals and states that are present on the web server itself, i.e. the monitoring support appliance, e.g. in the form of maintenance information or machine parameters. Toward that end, the technical appliance sends—e.g. by means of a software component—either partial information about signals detected on the controlling and/or regulating appliance to the web server, which information is combined there with further conditions to form an event, or it holds in readiness information provided locally by the web server, which information is combined e.g. in the software component itself to form an event. The latter-mentioned route is taken if it is necessary to initiate an action, e.g. a PLC data dump, on the technical appliance, which is to say e.g. the machine, immediately an event occurs and without having to wait for the response time of the web server.

According to the inventive method, a distributed monitoring system that is configurable at operating time can be implemented for a technical appliance, wherein:
a response is triggered in realtime both to pure states in the technical appliance (in particular a controlling and/or regulating appliance) and to states from other systems (through the provisioning of information from the web server, which serves as a monitoring support appliance), and/or
diagnostic information is made available in response to events, and/or
further working processes are initiated (e.g. by means of a notification to a user).

The change to the monitoring configuration is made in particular during operation of the technical appliance without the need for, say, a machine's production process to be interrupted.

Moreover, the method according to the invention can be embodied in such a way that at least a part of the monitoring configuration can be consolidated in a configuration setting, with one and/or more configuration settings being stored in the technical appliance and/or in the monitoring support appliance. A monitoring configuration becomes a configuration setting as a result of its being stored. Different monitoring configurations are advantageously stored on the monitoring support appliance. Said monitoring configurations can then be transferred to the technical appliance by means of a communication link. The choice of a particular monitoring configuration is dependent in particular on an error message and/or warning message that has occurred. In this case the choice can be made by the technical appliance itself, such that the technical appliance requests the right configuration required from the monitoring support appliance. In a further embodiment of the method, the error message and/or warning message is transferred to the monitoring support appliance, with the choice of the monitoring configuration being made in the monitoring support appliance. Said monitoring support appliance is embodied in particular as a web server, the latter having access to a database containing different monitoring configurations.

In an event situation, data dumps are performed, for example, as well as other actions (e.g. the sending of messages to a user) which can also be stored on the web server and can be adapted as necessary during the operating time of the technical appliance. Exporting different monitoring configurations to the monitoring support appliance, which is set up at a physically remote location from the technical appliance, enables updates to the configurations to be performed considerably more easily. The monitoring configuration appliance is operated for example by the manufacturer of the technical appliance, in which case the monitoring configuration appliance is connected to the technical appliance via the internet. The manufacturer possesses the experience with the technical appliance and can therefore make a better contribution toward faster troubleshooting of errors.

The monitoring method can also be embodied in such a way that a configuration setting is activated for the technical appliance. When the configuration setting is activated, a specific, previously stored monitoring configuration is therefore switched to active. Prior to the activation the monitoring configuration was stored for example on the technical appliance or on the monitoring support appliance.

In a further advantageous embodiment, the configuration setting is activated automatically by an already active configuration setting, i.e. by the active monitoring configuration. This initiation is therefore effected from the technical appliance itself. In a further embodiment, however, the activation of the configuration setting can be initiated by the appliance providing monitoring support.

In addition to the activation of a configuration setting, a deactivation of said configuration setting can also be performed. Furthermore it is also advantageously possible to activate at least two configuration settings, thereby producing a combined monitoring configuration.

### BRIEF DESCRIPTION OF THE DRAWINGS

Exemplary embodiments of the invention are illustrated in the drawing and explained in the following. The figures show:

FIG. 1 a schematic representation of a system used in the realization of the invention and

FIG. 2 schematically represented steps of a method for monitoring a technical appliance

### DETAILED DESCRIPTION OF INVENTION

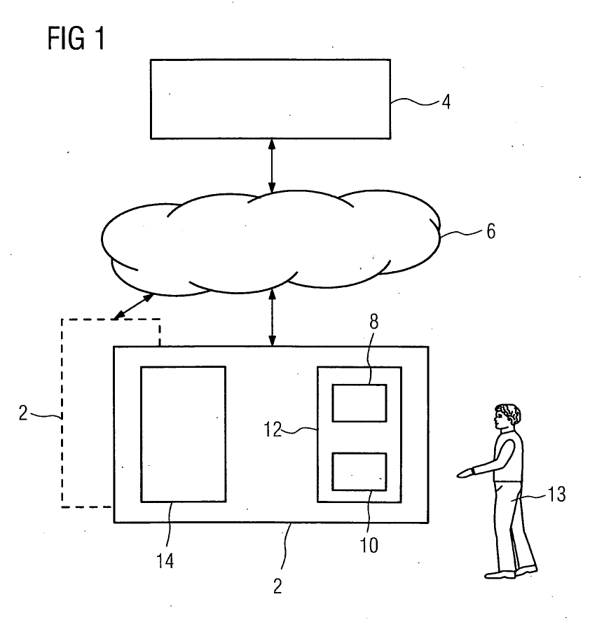

The diagram according to FIG. 1 shows by way of example a schematic representation of a system used in the realization of the invention. The system has a technical appliance 2, a monitoring support appliance 4 and a communication link 6. The communication link 6 is for example a:
network connection such as can be implemented e.g. via the internet or an intranet or a LAN network, or
a connection established with the aid of a telecommunications link.

The appliance 4 providing monitoring support to the technical appliance 2 is a server, for example.

The technical appliance 2 can be embodied as what is termed an “interactive client”, i.e. provided with an input unit 8 and output units 10 for an HMI 12, so that an operator 13 can control the monitoring by means of inputs. In the present example the HMI (Human Machine Interface) therefore has an input unit 8 (e.g. a keyboard) and an output unit 10 (e.g. a screen). The technical appliance 2 is, for example, a machine tool, the machine tool having a controlling and/or regulating appliance 14. The monitoring support appliance 4 can also be used by a plurality of technical appliances 2, such as e.g. for a plurality of production machines. A second technical appliance 2 is represented symbolically by dashed lines, said appliance also being connected to the monitoring support appliance 4 via the communication link 6. The double arrows between the appliances denote the data communication.

The present invention permits services for monitoring the technical appliance or for monitoring a device or machine for which the technical appliance is provided, to be provided for the technical appliances 2 or for e.g. the regulating and/or controlling appliance 14 as an embedded device via the communication link 6, wherein technical features (e.g. data and/or functions) of said devices or machines are used. Within the scope of the invention, configuration settings for monitoring are loaded by the monitoring support appliance 4 via the communication link 6 onto the technical appliance 2 and executed there.

In the field of industrial automation technology and in particular in the field of numerically controlled processing machines, manufacturers provide service in the form of controller technology and corresponding software components or embedded devices G for other manufacturers of original equipment (called “Original Equipment Manufacturers”, or OEMs) that manufacture and market industrial processing machines.

With the aid of the present invention it is possible to provide an end customer who has purchased e.g. a machine from an OEM with improved monitoring of the technical appliance 2. By this means the availability of the machines, their useful life and their productivity, for example, can be substantially improved.

The technical appliance 2 according to FIG. 1 is in particular an industrial machine such as for example a machine tool, a production machine or an automatic handling machine. Machines of this kind have mechanisms for generating messages. Messages are understood to mean e.g. information relating to the activation state of the industrial machine or other parameters relating to the industrial machine which describe their status such as, for example, temperatures, operating times, pressures or error messages. Error messages are generated for example when the industrial machine is in a status which deviates from its normal operating state. Causes of error messages are for example the failure of a component, disruption to motion sequences, exceeding of temperatures, exceeding of pressures, absence of an operating resource, exceeding of electrical currents and electrical voltages or, for example, also loss of the supply voltage. Alarm messages are also to be understood as error messages. Alarm messages are messages which, for example, report a critical state or a critical state that will possibly soon occur and which may restrict the operation of the industrial machine, such as e.g. also raw materials that are running low for industrial machines that process raw materials. Alarm messages also relate e.g. to operating hour counts.

Industrial machines often consist of different components. Many machine tools have electric drives, for example. The electric motor of an electric drive is fed for example by an inverter. Both the motor and the inverter are components and can be executed in such a manner that these components generate messages. Components, in turn, can have further subcomponents which possess the capability of generating error messages themselves. Worthy of mention merely as an example thereof are inverters which have a power section and a control section.

Messages such as e.g. error messages are generated by an industrial machine or its components. Said messages are provided to a message diagnosis appliance. The messages are provided for example locally at the industrial machine or externally.

In the case of an external message diagnosis appliance, data communication equipment such as, for example, telephone lines, radio links e.g. via a mobile telephone, data networks such as LANs or WANs, or the internet can be used. In the case of local message diagnosis appliances, the message diagnosis is advantageously carried out for example on an already existing data processing appliance, such as for example a numerical controller, a computerized numerical controller or a programmable logic controller. Associated troubleshooting measures or at least one troubleshooting measure are/is advantageously stored in each case in conjunction with the error messages received in the message diagnosis appliance.

On systems with at least partially occurring common parts, a central appliance providing monitoring support has the advantage that the knowledge base, i.e. the data relating to troubleshooting, is expanded in an improved manner on a centralized basis.

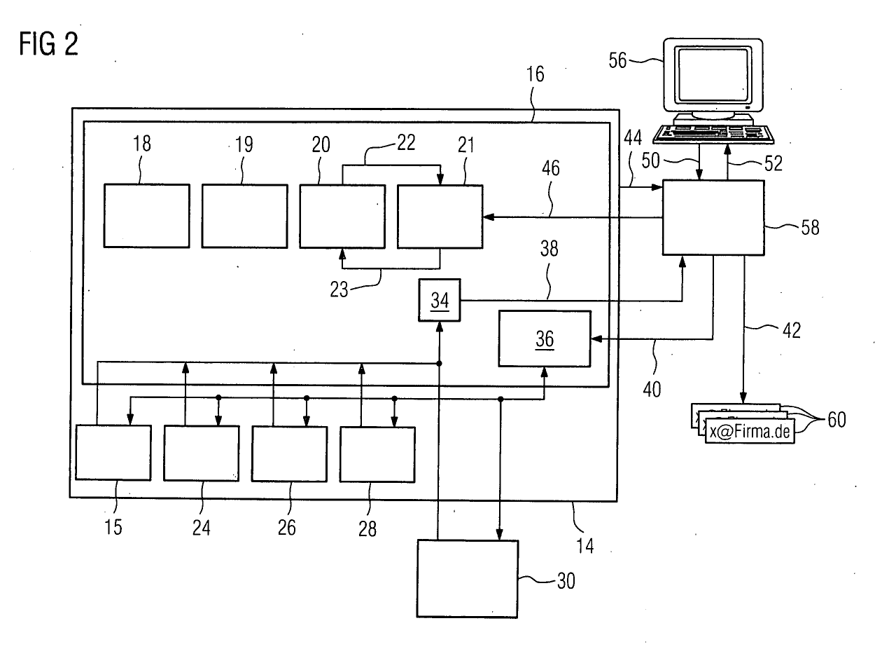

The schematic according to FIG. 2 shows an overview of a possible embodiment of the inventive method or inventive system. The figure shows an appliance 14 for regulating and/or controlling an industrial machine (not shown). The regulating and/or controlling appliance 14 has monitoring software 16. Different configuration settings 18, 19, 20 and 21 for monitoring the industrial machine, which is a technical appliance, are stored in the regulating and/or controlling appliance 14. The monitoring software 16 is able to perform a data exchange with other software components. Said software components relate for example to PLC functions 15, numerical control functions 24, operator control functions 26 and/or operating system functions 28. A data exchange is also possible with an additional technical appliance 30. The data exchange serves in particular to combine signal states from different sources in accordance with the chosen or active monitoring configuration. Information and data collected from different sources can be transferred to a web server 58 by means of a supplementary function 34. The web server 58 serves as the appliance providing monitoring support. The web server 58 hosts the most disparate functions and software components of the regulating and/or controlling appliance 14, this being indicated in FIG. 2 in particular by means of arrows. Information can be overlaid with the aid of a function 36. Said information relates for example to a maintenance status or also to a machine parameter. The arrows can represent the following functions:
Function 40 indicates that the web server 58 provides information for combining with controller states.
Function 42 indicates that the web server 58 can initiate further actions in accordance with a predefined action, where an action 60 relates for example to the sending of emails.
Function 38 indicates a feedback message relating to events and/or collected data.
Function 50 indicates that a monitoring configuration can be set by an operator by means of an operator control device 56, said setting being stored in a configuration setting.
Function 52 indicates that the operator can analyze events and diagnostic data via the operator control device 56.
Function 44 indicates that the monitoring software 16 addresses a request to the web server 58 relating to the retrieval of a monitoring configuration.
Function 46 indicates for example the activation or deactivation of a configuration, or also a feedback message relating to events and/or collected data.

The method or system shown in FIG. 2 thus has a monitoring software component 16 which is installed on a network-attached controlling and/or regulating appliance 14, and there monitors signals in relation to the reaching of specific signal values, and a web server which is informed by the software component 16 on the controlling and/or regulating appliance 14 about the occurrence of a specific combination of said signal values—“event”. Advantageously the event is stored complete with a timestamp and provided for diagnostic purposes. The monitoring configurations can be stored as settings on the web server and can be produced and adapted there by the operator during the operating time of the controller. They are retrieved automatically, e.g. in the form of scripts in a script language, from the web server 58 via a network connection by the software component 16 on the controlling and/or regulating appliance and interpreted in the software component 16. By this means a freely configurable monitoring logic is implemented at runtime without halting the controlling and/or regulating appliance or the production process.

In the inventive embodiment according to FIG. 2 the monitoring software has four configuration settings 18, 19, 20 and 21. The configuration settings 18, 19 and 20 are switched to active and collectively form a monitoring configuration. The configuration setting 21 is inactive.

In the configuration setting 18 there is stored, for example, the monitoring function to the effect that if the condition “PLC signal1=1 AND NC signal=55,3” is met, the following action is to be initiated: “send PLC data word 5 to web server”. Additionally, the configuration setting can also include further monitoring functions.

In the configuration setting 19 there is stored, for example, the monitoring function to the effect that if the condition “NC signal=drive defective AND status of monitoring jobs=jobs overdue” is met, the following action is to be started: “send email to maintenance”.

In the configuration setting 20 there is stored, for example, the monitoring function to the effect that if the condition “NC alarm=drive defective” is met, the following action is to be started: “activate configuration setting 21 AND deactivate configuration setting 20”. Advantageously it is therefore possible that configuration settings can mutually activate and/or deactivate one another. This function is illustrated in FIG. 2 by the arrows 22 and 23.

In the configuration setting 21 there is stored, for example, the monitoring function to the effect that if the condition “NC alarm=drive defective, special case 1” is met, the following action is to be started: “send NC status data to server AND activate configuration setting 20 AND deactivate configuration setting 21”.

The monitoring mechanism shown has various advantageous functions:
freely configurable monitors in the sense of configuration settings and the capability to cascade said settings,
scripts serving the evaluation in a machine handler, where this can relate both to logical combination handling and to evaluation logic,
freely configurable realtime PLC chips, with their behavior or function being parameterizable.

With the system described it is possible to maintain subsequently detected error states and responses necessary therefor via the system, so that they appear transparent to the user/operator of the system compared with those defined a priori in the automation project. For machine manufacturers/operators, more particularly in the field of special-purpose machines, this means a time/productivity gain, since not all potential fault situations are known here at the time of commissioning and these, when they occur, must be maintained on the system, which in general invariably necessitates a system shutdown.

By means of the system described it is made possible for machine manufacturers and operators to detect sporadically occurring malfunctions that were not known in advance at the time of commissioning of a system which is a technical appliance, on said system:
without the need to add dedicated diagnostic hardware and
without interrupting the production process.

As a result of the use of a software component whose behavior is freely configurable by means of scripts it is made possible:
to define logical combinations of any signals from the controlling and/or regulating appliance subsequently as an event and to respond to these,
to execute data-generating actions on the controlling and/or regulating appliance; in this case the precise type of the data that is to be generated does not need to be known at the time of implementation of the automation project.

1-6. (canceled)

7. A method for monitoring a technical device, comprising:
establishing a communication link between the technical device and a monitoring support device, wherein the monitoring of the technical device is configurable;
transferring changes to a monitoring configuration by the monitoring support device to the technical device;
storing a configuration settings in the technical device or in the monitoring support device, wherein at least a part of the monitoring configuration is consolidated in the configuration setting; and
switching the monitoring configuration setting of a first technical device to a further configuration setting based upon a status of a second technical device, wherein the monitoring support device is connected in a serial or parallel sequence to a plurality of technical device for the purpose of performing a data communication.

8. The method as claimed in claim 7, wherein the change to the monitoring configuration is carried out during operation of the technical device.

9. The method as claimed in claim 7, wherein a configuration setting is activated for the technical device.

10. The method as claimed in claim 8, wherein a configuration setting is activated for the technical device.

11. The method as claimed in claim 7, wherein the configuration setting initiates a further configuration setting.

12. The method as claimed in claim 7, wherein the monitoring support device initiates a further configuration setting.

13. The method as claimed in claim 7, wherein a configuration setting is deactivated for the technical device.

14. The method as claimed in claim 7, wherein a message is generated by the technical device and by the monitoring support device, whereby a function stored in the technical device and in the monitoring support device is initiated based upon the message.

15. The method as claimed in claim 7, wherein a message is generated by the technical device or by the monitoring support device, whereby a function stored in the technical device or in the monitoring support device is initiated based upon the message.

16. A method for monitoring a machine tool, comprising:
establishing a communication link between the machine tool and a monitoring support device, wherein the monitoring of the machine tool is configurable;
transferring changes to a monitoring configuration by the monitoring support device to the machine tool;
storing a configuration setting in a web server, wherein at least a part of the monitoring configuration is consolidated in the configuration setting; and
switching the monitoring configuration setting of a first machine tool to a further configuration setting based upon a status of a second machine tool, wherein the monitoring support device has a data connection to a plurality of technical devices.

17. The method for monitoring a machine tool as claimed in claim 16, wherein the further configuration setting is activated and the previously active configuration setting is deactivated in case of an alarm showing a drive is defective.

18. A method for monitoring a production machine, comprising:
establishing a communication link between the production machine and a monitoring support device, wherein the monitoring of the machine tool is configurable;
transferring changes to a monitoring configuration by the monitoring support device to the production machine;
storing a configuration settings in the production machine and in the monitoring support device, wherein at least a part of the monitoring configuration is consolidated in the configuration setting; and
switching the monitoring configuration setting of a first machine tool to a further configuration setting based upon a status of a second machine tool, wherein the monitoring support device is connected in a serial and/or parallel sequence to a plurality of technical appliances for the purpose of performing a data communication.

19. The method for monitoring a production machine as claimed in claim 18, wherein the further configuration setting is activated and the previously active configuration setting is deactivated in case of an alarm showing a drive is defective.
